(19) United States
(12) Patent Application Publication
(10) Pub. No.: US 2026/0311679 A1
(43) Pub. Date: Oct. 8, 2026

(54) METHOD FOR DETERMINING SPEECH DATASET, ELECTRONIC DEVICE AND STORGE MEDIUM

(71) Applicant: BAIDU INTERNATIONAL TECHNOLOGY (SHENZHEN) CO., LTD., Shenzhen (CN)

(72) Inventors: Xiaolong Lin, Shenzhen (CN); Yiqiao Huang, Shenzhen (CN); Zhenpeng Zhan, Shenzhen (CN); Gang Qiao, Shenzhen (CN)

(73) Assignee: BAIDU INTERNATIONAL TECHNOLOGY (SHENZHEN) CO., LTD., Shenzhen (CN)

(21) Appl. No.: 19/461,265

(22) Filed: Jan. 27, 2026

(30) Foreign Application Priority Data
Sep. 19, 2025 (KR) 202511350651.8

(51) Int. Cl. G10L 13/027; G10L 17/02; G10L 17/04; G10L 21/0216; G10L 21/028; G10L 25/60; G10L 25/63; G10L 25/78

(52) U.S. Cl. CPC G10L 13/027; G10L 17/02; G10L 17/04; G10L 21/0216; G10L 21/028; G10L 25/60; G10L 25/63; G10L 25/78

(57) ABSTRACT

The disclosure provides a method for determining a speech dataset, an apparatus and an electronic device, and relates to a field of artificial intelligence technologies, such as deep learning, natural language processing, speech technology and large model. The method includes: obtaining a set of speech fragments and obtaining texts corresponding to the speech fragments respectively; determining, for each of the speech fragments, a first emotion type of the speech fragment, an emotion intensity of the first emotion type, a second emotion type of a text corresponding to the speech fragment, and an emotion intensity of the second emotion type; determining whether to retain the speech fragment based on the first emotion type, the emotion intensity of the first emotion type, the second emotion type and the emotion intensity of the second emotion type; and determining a speech dataset based on speech fragments retained in the set of speech fragments and texts corresponding to the speech fragments retained. Whether or not to reserve the speech segment is determined based on the emotion intensity of the emotion type, which ensures the emotion intensity of the emotion type of the speech fragment in the speech dataset. Therefore, the speech synthesis model trained based on the speech dataset is able to synthesize speeches expressing real emotions.

### CROSS REFERENCE TO RELATED APPLICATIONS

This application claims priority and benefits to Chinese Application No. 2025113506518, filed on Sep. 19, 2025, the entire content of which is incorporated herein by reference.

### TECHNICAL FIELD

The disclosure relates to the field of artificial intelligence technologies, such as deep learning, natural language processing, speech technology and large model, in particular to a method for determining a speech dataset, an apparatus and an electronic device.

### BACKGROUND

Currently, speech fragments in a speech dataset used to train speech synthesis models are primarily originate from scenarios such as audio readings and news broadcasts. However, the speech fragments obtained from the above scenarios exhibit relatively monotonous emotion expression and lack dynamic variation, resulting in speech synthesis models producing speeches with emotion expressiveness that falls short of requirements.

### SUMMARY

The disclosure provides a method for determining a speech dataset, an apparatus and an electronic device.

According to a first aspect of the disclosure, a method for determining a speech dataset is provided. The method includes: obtaining a set of speech fragments and obtaining texts corresponding to the speech fragments respectively; determining, for each of the speech fragments, a first emotion type of the speech fragment, an emotion intensity of the first emotion type, a second emotion type of a text corresponding to the speech fragment, and an emotion intensity of the second emotion type; determining whether to retain the speech fragment based on the first emotion type, the emotion intensity of the first emotion type, the second emotion type and the emotion intensity of the second emotion type; and determining a speech dataset based on speech fragments retained in the set of speech fragments and texts corresponding to the speech fragments retained.

According to a second aspect of the disclosure, a method for training a speech synthesis model is provided. The method includes: obtaining a speech dataset, in which the speech dataset includes speech fragments, emotion types of the speech fragments and texts corresponding to the speech fragments, and the speech dataset is determined according to the method for determining the speech dataset described above; obtaining an initial speech synthesis model; and obtaining a trained speech synthesis model by training the initial speech synthesis model according to the speech fragments, the emotion types of the speech fragments and the texts.

According to a third aspect of the disclosure, an apparatus for determining a speech dataset is provided. The apparatus includes: an obtaining module, configured to obtain a set of speech fragments and obtain texts corresponding to the speech fragments respectively ; a first determining module, c configured to determine, for each of the speech fragments, a first emotion type of the speech fragment, an emotion intensity of the first emotion type, a second emotion type of a text corresponding to the speech fragment, and an emotion intensity of the second emotion type; a second determining module, configured to determine whether to retain the speech fragment based on the first emotion type, the emotion intensity of the first emotion type, the second emotion type and the emotion intensity of the second emotion type; and a third determining module, configured to determine a speech dataset based on speech fragments retained in the set of speech fragments and the texts corresponding to the speech fragments retained.

According to a fourth aspect of the disclosure, an apparatus for training a speech synthesis model is provided. The apparatus includes: a first obtaining module, configured to obtain a speech dataset, in which the speech dataset includes speech fragments, emotion types of the speech fragments and texts corresponding to the speech fragments, and the speech dataset is determined according to the method for determining the speech dataset described above; a second obtaining module, configured to obtain an initial speech synthesis model; and a training module, configured to obtain a trained speech synthesis model by training the initial speech synthesis model based on the speech fragments, the emotion types of the speech fragments and the texts.

According to a fifth aspect of the disclosure, an electronic device is provided. The electronic device includes: at least one processor and a memory communicatively connected to the at least one processor; in which the memory stores instructions executable by the at least one processor, and when the instructions are executed by the at least one processor, the at least one processor is caused to implement the method for determining the speech dataset described above or the method for training the speech synthesis model described above.

According to a sixth aspect of the disclosure, a non-transitory computer-readable storage medium is provided. The medium stores computer instructions, and the computer instructions are used to cause a computer to implement the method for determining the speech dataset described above or the method for training the speech synthesis model described above.

According to a seventh aspect of the disclosure, a computer program product is provided. The product includes computer programs, and when the computer programs are executed by a processor, the method for determining the speech dataset described above or the method for training the speech synthesis model described above is implemented.

It should be understood that the content described in this section is not intended to identify key or important features of the embodiments of the disclosure, nor is it intended to limit the scope of the disclosure. Additional features of the disclosure will be easily understood based on the following descriptions.

### BRIEF DESCRIPTION OF THE DRAWINGS

The drawings are used to better understand the solution and do not constitute a limitation to the disclosure, in which:

FIG. 1 is a schematic diagram of a first embodiment of the disclosure.

FIG. 2 is a schematic diagram of a second embodiment of the disclosure.

FIG. 3 is a schematic diagram of a third embodiment of the disclosure.

FIG. 4 is a schematic diagram for determining a speech dataset.

FIG. 5 is a schematic diagram of a fourth embodiment of the disclosure.

FIG. 6 is a schematic diagram of a fifth embodiment of the disclosure.

FIG. 7 is a block diagram of an electronic device used to implement the method for determining the speech dataset or the method for training the speech synthesis model according to the embodiments of the disclosure.

### DETAILED DESCRIPTION

The following describes the example embodiments of the disclosure in combination with the accompanying drawings, which includes various details of the embodiments of the disclosure to facilitate understanding, which shall be considered merely exemplary. Therefore, those skilled in the art should understood that various changes and modifications can be made to the embodiments described herein without departing from the scope and spirit of the disclosure. For clarity and brevity, descriptions of well-known functions and structures are omitted in the following descriptions.

Currently, speech fragments in a speech dataset used to train speech synthesis models are primarily originate from scenarios such as audio readings and news broadcasts. However, the speech fragments obtained from the above scenarios exhibit relatively monotonous emotion expression and lack dynamic variation, resulting in speech synthesis models producing speeches with emotion expressiveness that falls short of requirements.

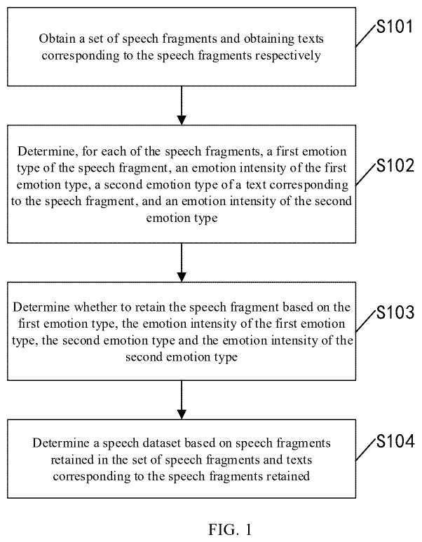

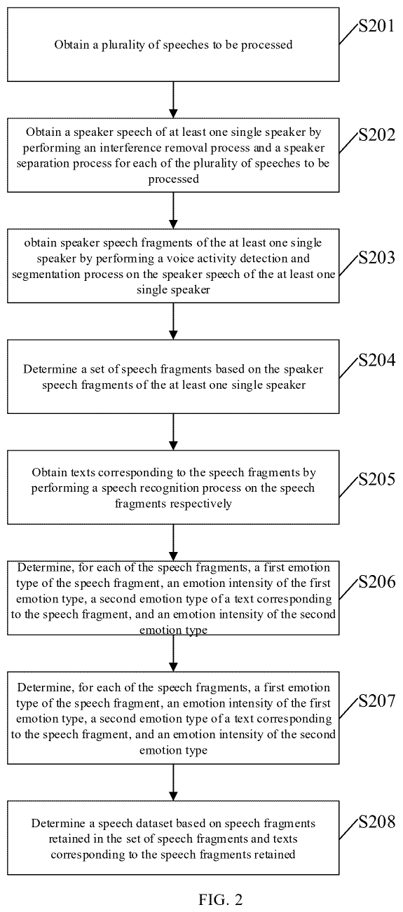

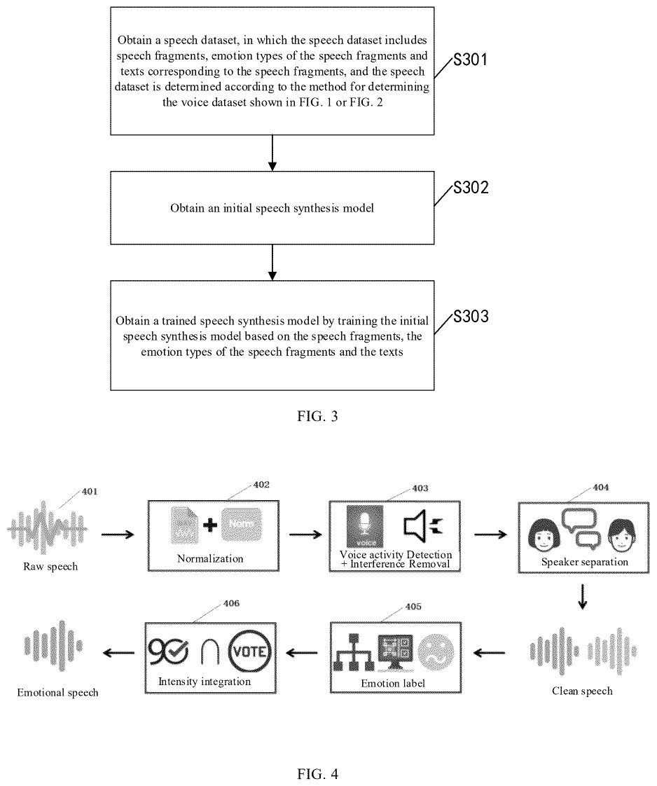

FIG. 1 is a schematic diagram of a first embodiment of the disclosure. It should be noted that a method for determining a speech dataset in the embodiment of the disclosure may be applied to an apparatus for determining a speech dataset. The apparatus is configured in an electronic device, so that the electronic device possess the function of determining the speech dataset.

The electronic device may be any device with computing capabilities, such as a personal computer (PC), a mobile terminal and a server. The mobile terminal may be, for example, a vehicle-mounted device, a mobile phone, a tablet computer, a personal digital assistant, a wearable device, a smart speaker, a server, a server cluster or other hardware devices with various operating systems, touch screens and/or displays.

The apparatus for determining the speech dataset may be a software in the electronic device, e.g., a software for determining the speech dataset. In the following embodiments, the electronic device is taken as the execution entity as an example.

As illustrated in FIG. 1, the method for determining the speech dataset includes the following steps.

At step 101, a set of speech fragments is obtained and texts corresponding to the speech fragments respectively are obtained respectively.

In the embodiments of the disclosure, a speech fragment may be a speech fragment of a single speaker after removing interferences such as background sound and noises. The speech fragment may come from, for example, the speech of any speaker, the speech of any video, which may be set according to actual needs and is not specifically limited herein.

A language type of the speech fragment may be any language type or target language type, e.g., Chinese or English, which is not specifically limited here.

At step 102, for each of the speech fragments, a first emotion type of the speech fragment, an emotion intensity of the first emotion type, a second emotion type of a text corresponding to the speech fragment, and an emotion intensity of the second emotion type are determined.

In the embodiments of the disclosure, for example, the process for the electronic device to execute step 102 includes: inputting the speech fragment into an acoustic feature model, and obtaining at least one first candidate emotion type, and a first probability and an emotion intensity of the at least one first candidate emotion type output by the acoustic feature model; selecting the first emotion type from the at least one first candidate emotion type based on the first probability; inputting the speech fragment into a semantic understanding model, and obtaining at least one second candidate emotion type, and a second probability and an emotion intensity of the at least one second candidate emotion type output by the semantic understanding model; and selecting the second emotion type from the at least one second candidate emotion type based on the second probability.

In the embodiments of the disclosure, there may be a plurality of acoustic feature models. The acoustic feature models may have different model structures. The acoustic feature model is capable of capturing prosodic variations, pitch dynamics and energy changes in the speech fragment, thereby assessing the emotion tension of the speech fragment at the expression level, i.e., the emotion intensity of the emotion type.

The emotion intensity of the emotion type is determined based on the prosodic variations, pitch dynamics and energy changes in the speech fragment. The prosodic variations may be represented by a maximum difference in fundamental frequency within a fundamental frequency dynamic range of the speech fragment. The greater the maximum difference, the greater the prosodic variation of the speech fragment. The pitch dynamics may be represented by a standard deviation of the fundamental frequency of the speech fragment. The greater the standard deviation of the fundamental frequency, the greater the amplitude of the pitch fluctuation of the speech fragment. The energy changes may be represented by an energy standard deviation of the speech fragment. The greater the energy standard deviation, the greater the amplitude fluctuation of the speech fragment.

The emotion intensity of the emotion type may be positively correlated with the values of the following three parameters of the speech fragment: the maximum difference in the fundamental frequency within the fundamental frequency dynamic range, the standard deviation of the fundamental frequency and the energy standard deviation. The emotion intensity of the emotion type is obtained based on a weighted sum of at least two of the above three parameters of the speech fragment.

The acoustic feature model may be, for example, an emotion vector model (Emotion2Vec), an emphasized channel attention, propagation and aggregation in time domain neural network (TDNN) (ECAPA-TDNN), a deep residual network (ResNet)-speech emotion recognition (SER) model, which can be set according to actual needs and is not specifically limited herein.

It is determined whether to retain the speech fragment based on the first emotion type and the emotion intensity of the first emotion type output by the acoustic feature model. Therefore, speech fragments with higher emotion intensity are selected, which enhances the emotion authenticity of the speech fragments in the speech dataset.

There may be a plurality of semantic understanding models. The semantic understanding models may have different model structures. The semantic understanding model can extract the emotion intention contained in the text, so as to evaluate the emotion type and the emotion intensity of the emotion type in the text.

The semantic understanding model may be, for example, bidirectional encoder representations from transformers (BERT)+Text-Classifier, or a SenseVoice model, which can be set according to actual needs and is not specifically limited herein.

It is determined whether to retain the speech fragment based on the second emotion type and the emotion intensity of the second emotion type output by the semantic understanding model. This approach selects speech fragments with higher emotion intensity—that is, those exhibiting stronger emotion tension—for inclusion in the speech dataset. Consequently, the emotion authenticity of the speech fragments in the speech dataset is enhanced.

At step 103, it is determined whether to retain the speech fragment based on the first emotion type, the emotion intensity of the first emotion type, the second emotion type and the emotion intensity of the second emotion type.

In the embodiments of the disclosure, in an example, the process for the electronic device to execute step 103 includes: determining whether the first emotion type is consistent with the second emotion type, and determining whether the emotion intensity of the first emotion type and the emotion intensity of the second emotion type are greater than or equal to an emotion intensity threshold; and if the first emotion type is consistent with the second emotion type, and in a case that the first emotion type is consistent with the second emotion type, and the emotion intensity of the first emotion type and the emotion intensity of the second emotion type are both greater than or equal to the emotion intensity threshold, determining to retain the speech fragment; and in a case that the first emotion type is inconsistent with the second emotion type, or in a case that the emotion intensity of the first emotion type is less than the emotion intensity threshold, or in a case that the emotion intensity of the second emotion type is less than the emotion intensity threshold, determining not to retain the speech fragment.

If the first emotion type is inconsistent with the second emotion type, it means that the speech fragment does not use the correct emotion type to express the text. If the emotion intensity of the first emotion type is less than the emotion intensity threshold, it indicates that the emotion expressiveness of the speech fragment is poor.

It is determined whether the first emotion type is consistent with the second emotion type and whether the emotion intensity of the first emotion type and the emotion intensity of the second emotion type are greater than or equal to the emotion intensity threshold, and then it is determined whether to retain the speech fragment, which ensures the emotion consistency between the retained speech fragment and the corresponding text.

As an alternative scheme to the above scheme, the electronic device may determine to retain the speech fragment if the emotion intensity of the first emotion type and the emotion intensity of the second emotion type are both greater than or equal to the emotion intensity threshold, and determine not to retain the speech fragment if the emotion intensity of the first emotion type is less than the emotion intensity threshold or if the emotion intensity of the second emotion type is less than the emotion intensity threshold.

In the embodiments of the disclosure, in another example, there are a plurality of first emotion types and a plurality of second emotion types. Correspondingly, the process for the electronic device to execute step 103 includes: in a case that the plurality of first emotion types are consistent, determining a total emotion intensity of the plurality of first emotion types based on emotion intensities of the plurality of first emotion types and a weight used by an acoustic feature model for determining the plurality of first emotion types; in a case that the plurality of the second emotion types are consistent, determining a total emotion intensity of the plurality of second emotion types based on emotion intensities of the plurality of second emotion types and a weight used by a semantic understanding model for determining the plurality of second emotion types; and determining whether to retain the speech fragment based on the plurality of first emotion types, the total emotion intensity of the plurality of first emotion types, the plurality of second emotion types and the total emotion intensity of the plurality of second emotion types; in a case that the plurality of first emotion types are inconsistent, or in a case that the plurality of second emotion types are inconsistent, determining not to retain the speech fragment.

The weight of the acoustic feature model is determined based on its determination accuracy for the emotion type. The determination accuracy is positively correlated with the weight. The weight of the semantic understanding model is determined based on its determination accuracy for the emotion type. The determination accuracy is also positively correlated with the weight.

In an example, the process for the electronic device to determine whether to retain the speech fragment based on the plurality of first emotion types, the total emotion intensity of the plurality of first emotion types, the plurality of second emotion types and the total emotion intensity of the plurality of second emotion types includes: if the first emotion types are consistent with the second emotion types, and the total emotion intensity of the first emotion types and the total emotion intensity of the second emotion types are both greater than or equal to the emotion intensity threshold, determining to retain the speech fragment; and if the first emotion types are inconsistent with the second emotion types, if the total emotion intensity of the first emotion types is less than the emotion intensity threshold, or if the total emotion intensity of the second emotion types is less than the emotion intensity threshold, determining not to retain the speech fragment.

In another example, the process for the electronic device to determine whether to retain the speech fragment based on the plurality of first emotion types, the total emotion intensity of the plurality of first emotion types, the plurality of second emotion types and the total emotion intensity of the plurality of second emotion types includes: if the total emotion intensity of the first emotion types and the total emotion intensity of the second emotion types are both greater than or equal to the emotion intensity threshold, determining to retain the speech fragment; and if the total emotion intensity of the first emotion types is less than the emotion intensity threshold, or if the total emotion intensity of the second emotion types is less than the emotion intensity threshold, determining not to retain the speech fragment.

The total emotion intensity of the first emotion types is determined based on the weight of the acoustic feature model, and the total emotion intensity of the second emotion types is determined based on the weight of the semantic understanding model. By determining whether the first emotion types are consistent with the second emotion types, and whether the total emotion intensity of the first emotion types and the total emotion intensity of the second emotion types are greater than or equal to the emotion intensity threshold, it is determined whether to retain the speech fragment, which ensures the emotion consistency between the reserved speech fragment and the corresponding text.

At step 104, a speech dataset is determined based on speech fragments retained in the set of speech fragments and texts corresponding to the speech fragments retained.

In the embodiment of the disclosure, in order to facilitate the following training process of the speech synthesis model that can control the emotion types, the electronic device determines the speech dataset based on one of the retained speech fragments in the speech dataset, the text, the first emotion type and the second emotion type corresponding to the retained speech fragments.

In the embodiment of the disclosure, after step 104, the electronic device may also fine-tune the acoustic feature model and the semantic understanding model based on the speech fragments of different language types in the speech dataset and the texts corresponding to the speech fragments.

By fine-tuning the acoustic feature model and the semantic understanding model based on the speech fragments of different language types and the texts corresponding to the speech fragments in the speech dataset, the accuracy of the acoustic feature model and the semantic understanding model are improved, which further improves the accuracy of determining the speech dataset.

According to the method for determining the speech dataset in the embodiments of the disclosure, the set of speech fragments is obtained and the texts corresponding to the speech fragments are obtained respectively. For each of the speech fragments, the first emotion type of the speech fragment, the emotion intensity of the first emotion type, the second emotion type of the corresponding text, and the emotion intensity of the second emotion type are determined. It is determined whether to retain the speech fragments based on the first emotion type, the emotion intensity of the first emotion type, the second emotion type and the emotion intensity of the second emotion type. Finally, the speech dataset is determined based on the retained speech fragments in the set of speech fragments and the texts corresponding to the retained speech fragments. Among these, determining whether to retain the speech fragment based on the emotion intensity of the emotion type ensures the emotion intensity of the emotion type of the speech fragment in the speech dataset. Moreover, the speech synthesis model trained based on the speech dataset is able to synthesize speeches expressing real emotions.

To further improve the richness of the emotion types of the speech fragments, any speech can be processed to obtain set of speech fragments. As illustrated in FIG. 2, FIG. 2 is a schematic diagram of a second embodiment of the disclosure, and the embodiment of FIG. 2 includes the following steps.

At step 201, a plurality of speeches to be processed are obtained.

At step 202, a speaker speech of at least one single speaker is obtained by performing an interference removal process and a speaker separation process for each of the plurality of speeches to be processed.

In the embodiment of the disclosure, the process for the electronic device to execute step 202 includes: obtaining a separated speech output by a sound source separation model by inputting a speech into a source separation model; and obtaining a speaker speech of each speaker output by a speaker separation model by inputting the separated sound into the speaker separation model.

The source separation model is used to separate interference noises such as background sound and noises from the speech to obtain the separated speech, that is, the speech after removing the interference noises. The speaker speech of each speaker is the speech of a single speaker.

In the embodiment of the disclosure, in order to improve the efficiency of removing interference noises for the speech and the efficiency of separating speakers, before step 202, the format of each speech needs to be unified. For example, at least one of a sampling rate, channel information or volume information of the speech is unified. The unified sampling rate may be, for example, 24 kHz, and the unified volume information may be, for example, −20 dBFS.

At step 203, speaker speech fragments of the at least one single speaker is obtained by performing a voice activity detection and segmentation process on the speaker speech of the at least one single speaker.

In the embodiment of the disclosure, the process for the electronic device to execute step 203 includes: for each speaker speech of the at least one single speaker, inputting the speaker speech into the voice activity detection model and obtaining a segmentation result output by the voice activity detection model, in which the segmentation result includes individual speaker speech fragments of a single speaker. The speaker speech fragment is a fragment containing the speech of a single speaker.

At step 204, the set of speech fragments are determined based on the speaker speech fragments of the at least one single speaker.

In the embodiment of the disclosure, in order to further ensure that the speaker speech is the speech of a single speaker, before step 204, for the speaker speech of the single speaker, the electronic device may determine whether there is an overlapped fragment in the speaker speech by performing an overlapped speaker detection process on the speaker speech. In a case that the overlapped fragment exists in the speaker speech, the overlapped fragments are removed from the speaker speech.

The electronic device inputs the speaker speech into an overlap detection model to obtain the overlapped fragment output by the overlap detection model, determines a starting time of the overlapped fragment and removes the overlapped fragment from the speaker speech based on the starting time.

In the embodiment of the disclosure, in order to further improve the quality of the speech fragments in the set of speech fragments, before step 204, the electronic device may, for each speaker speech fragment of the at least one single speaker, obtaining an audio quality score of the speaker speech fragment by performing an audio quality scoring process on the speaker speech fragment, and perform a filtering process on the speaker speech fragment based on the audio quality score and a duration of the speaker speech fragment.

For example, the process for the electronic device to perform the filtering process on the speaker speech fragment based on the audio quality score and a duration of the speaker speech fragment, includes: if the sound quality score is less than or equal to a score threshold, or if the duration is not within a duration range, performing the filtering process on the speaker speech fragment.

If the duration is not within the duration range, it indicates that the duration may be too short or too long. If the duration of the speaker speech fragment is too short, it may be difficult to detect the emotion type or the detected emotion type is inaccurate. If the duration of the speaker speech fragment is too long, the emotion type may not be fixed, and thus the detected emotion type may be inaccurate. The audio quality assessment is used to evaluate scores for the speaker speech fragment in terms of clarity and other aspects.

If the score is less than or equal to a score threshold, or if the duration is not within the duration range, the speaker speech fragment is filtered to enhance the quality of the retained fragment, which enhances the quality of the speech fragments in the set of speech fragment.

At step 205, the texts corresponding to the speech fragments are obtained by performing a speech recognition process on the speech fragments in the set of speech fragments.

In the embodiment of the disclosure, the process for the electronic device to execute step 205 includes: determining for each of the speech fragments a language type to which the speech fragment belongs; selecting a target speech recognition model from a plurality of candidate speech recognition models based on the language type; and obtaining the text output by the target speech recognition model by inputting the speech fragment into the target speech recognition model.

Different candidate speech recognition models achieve different processing accuracies for speech fragments of different language types. That is, different candidate speech recognition models is good at processing speech fragments belongs to different language types. Therefore, the target speech recognition model is selected from the plurality of candidate speech recognition models based on the language type for performing the speech recognition process on the speech fragment, which improves the accuracy of determining the obtained text.

At step 206, a first emotion type of the speech fragment, an emotion intensity of the first emotion type, a second emotion type of a text corresponding to the speech fragment, and an emotion intensity of the second emotion type are determined.

At step 207, it is determined whether to retain the speech fragments based on the first emotion type, the emotion intensity of the first emotion type, the second emotion type and the emotion intensity of the second emotion type.

At step 208, a speech dataset is determined based on the speech fragments retained in the set of speech fragments and the texts corresponding to the speech fragments retained.

It should be noted that the details of steps 206-208 may refer to steps 102-104 in the embodiment of FIG. 1, which will not be described in detail here.

According to the method for determining the speech dataset in the embodiments of the disclosure, the plurality of speeches to be processed are obtained. The speaker speech of the at least one single speaker is obtained by performing the interference removal process and a speaker separation process for each of the plurality of speeches to be processed. The speaker speech fragments of the at least one single speaker are obtained by performing the voice activity detection and segmentation process on the speaker speech of the at least one single speaker. The set of speech fragments is determined based on the speaker speech fragments of the at least one single speaker. The texts corresponding to the speech fragments are obtained by performing a speech recognition process on the speech fragments in the set of speech fragments. For each of the speech fragments, the first emotion type of the speech fragment, the emotion intensity of the first emotion type, the second emotion type of the text corresponding to the speech fragment, and the emotion intensity of the second emotion type are determined. It is determined whether to retain the speech fragments based on the first emotion type, the emotion intensity of the first emotion type, the second emotion type and the emotion intensity of the second emotion type. The speech dataset is determined based on the speech fragments retained in the set of speech fragments and the texts corresponding to the speech fragments retained. The speeches to be processed are subjected to the interference removal process, the speaker separation process, the voice activity detection and segmentation process to obtain the speech fragments, and the speech to be processed may be any speech. Therefore, the richness of the emotion types of the speech fragments can be improved, and the richness of the emotion types and the emotion authenticity of the speech fragments in the speech dataset can be improved.

FIG. 3 is a schematic diagram of a third embodiment of the disclosure. It should be noted that the method for training the speech synthesis model of the embodiment of the disclosure is applied to an apparatus for training a speech synthesis model. The apparatus may be configured in an electronic device, so that the electronic device possesses the function of training the speech synthesis model.

The electronic device may be any device with computing capabilities, such as a PC, a mobile terminal and a server. The mobile terminal may be, for example, a vehicle-mounted device, a mobile phone, a tablet computer, a personal digital assistant, a wearable device, a smart speaker, a server, a server cluster or other hardware devices with various operating systems, touch screens and/or displays.

The apparatus for training the speech synthesis model may be software in the electronic device, e.g., software for training the speech synthesis model. In the following embodiments, the electronic device is taken as the execution entity as an example.

As illustrated in FIG. 3, the method for training the speech synthesis model includes the following steps.

At step 301, a speech dataset is obtained, in which the speech dataset includes speech fragments, emotion types of the speech fragments and texts corresponding to the speech fragments, and the speech dataset is determined according to the method for determining the speech dataset shown in FIG. 1 or FIG. 2.

The speech fragments in the speech dataset may be speech fragments obtained after performing an interference removal process, a speaker separation process, a voice activity detection and segmentation process on any speech.

At step 302, an initial speech synthesis model is obtained.

The initial speech synthesis model may be a pre-trained speech synthesis model.

At step 303, a trained speech synthesis model is obtained by training the initial speech synthesis model based on the speech fragments, the emotion types of the speech fragments and the texts.

In the embodiment of the disclosure, the process for the electronic device to execute step 303 includes: obtaining a predicted speech fragment output by a speech synthesis model by inputting a text and an emotion type into the speech synthesis model; determining a value of a loss function based on the predicted speech fragment, a speech fragment correspond to the text and the loss function of the speech synthesis model; and obtaining a trained speech synthesis model by adjusting parameters of the speech synthesis model based on the value of the loss function.

The trained speech synthesis model is used for speech synthesis in at least one of a human-computer interaction scenario, a dubbing scenario, a script interpretation scenario or an anchor scenario, which is not limited herein. The human-computer interaction scenario may be a virtual human interaction scenario, a digital role interaction scenario, a customer service interaction scenario, an educational platform interaction scenario, a psychological counseling scenario, an emotion companionship scenario, an elderly assistant scenario and other interaction scenarios, which is not limited herein.

In the methods for training the speech synthesis model of the embodiment of the disclosure, the speech dataset is obtained, in which the speech dataset includes the speech fragments, the emotion types of the speech fragments and the texts corresponding to the speech fragments, and the speech dataset is determined according to the method for determining the speech dataset shown in FIG. 1 or FIG. 2. The initial speech synthesis model is obtained, and the trained speech synthesis model is obtained by training the initial speech synthesis model based on the speech fragments, the emotion types of the speech fragments and the texts. Since the emotion intensities of the emotion types of the speech fragments in the speech dataset are higher, the speech synthesis model is able to synthesize speech fragments expressing real emotions.

An example is illustrated in the following. As illustrated in FIG. 4, FIG. 4 is a schematic diagram for determining a speech dataset. FIG. 4 includes the following steps.

At step 401, a speech to be processed (i.e., raw speech in FIG. 4) is obtained.

At step 402, format unification processing is performed on the speech (i.e., normalization in FIG. 4).

At step 403, a plurality of speech fragments are obtained by performing an interference removal process and a voice activity detection process on the speech.

At step 404, speech fragments (i.e., clean speeches) in a set of speech fragments are obtained by performing a speaker separation process on the speech fragments.

At step 405, at least one emotion type (i.e., emotion label) of the speech fragments in the set of speech fragments and an emotion intensity of the emotion type are determined.

At step 406, speech fragments retained (i.e., emotional speeches) are obtained by determining whether to retain the speech fragments based to the at least one emotion type of the speech fragments and the emotion intensity of the emotion type (that is, determine whether to retain the speech fragments through intensity integration).

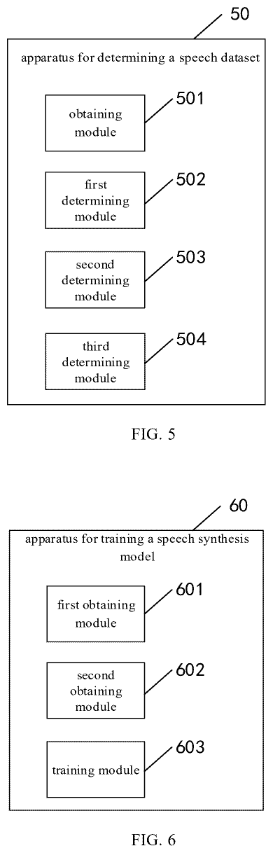

In order to implement the above embodiments, the disclosure also provides an apparatus for determining a speech dataset. As illustrated in FIG. 5, FIG. 5 is a schematic diagram of a fourth embodiment of the disclosure. The apparatus 50 for determining the speech dataset includes: an obtaining module 501, a first determining module 502, a second determining module 503 and a third determining module 504.

The obtaining module 501 is configured to obtain a set of speech fragments and obtain texts corresponding to the speech fragments respectively. The first determining module 502 is configured to determine, for each of the speech fragments, a first emotion type of the speech fragment, an emotion intensity of the first emotion type, a second emotion type of a text corresponding to the speech fragment, and an emotion intensity of the second emotion type. The second determining module 503 is configured to determine whether to retain the speech fragment based on the first emotion type, the emotion intensity of the first emotion type, the second emotion type and the emotion intensity of the second emotion type. The third determining module 504 is configured to determine a speech dataset based on speech fragments retained in the set of speech fragments and the texts corresponding to the speech fragments retained.

As a possible implementation of the embodiment of the disclosure, the first determining module 502 is further configured to: input the speech fragment into an acoustic feature model, and obtain at least one first candidate emotion type, and a first probability and an emotion intensity of the at least one first candidate emotion type output by the acoustic feature model; select the first emotion type from the at least one first candidate emotion type based on the first probability; input the speech fragment into a semantic understanding model, and obtain at least one second candidate emotion type, and a second probability and an emotion intensity of the at least one second candidate emotion type output by the semantic understanding model; and select the second emotion type from the at least one second candidate emotion type based on the second probability.

As a possible implementation of the embodiment of the disclosure, the second determining module 503 is further configured to: determine whether the first emotion type is consistent with the second emotion type, and determine whether the emotion intensity of the first emotion type and the emotion intensity of the second emotion type are greater than or equal to an emotion intensity threshold; and in a case that the first emotion type is consistent with the second emotion type, and the emotion intensity of the first emotion type and the emotion intensity of the second emotion type are both greater than or equal to the emotion intensity threshold, determine to retain the speech fragment.

As a possible implementation of the embodiment of the disclosure, the second determining module 503 is further configured to: in a case that the first emotion type is inconsistent with the second emotion type, or in a case that the emotion intensity of the first emotion type is less than the emotion intensity threshold, or in a case that the emotion intensity of the second emotion type is less than the emotion intensity threshold, determine not to retain the speech fragment.

As a possible implementation of the embodiment of the disclosure, the first emotion type comprises a plurality of first emotion types and the second emotion type comprises a plurality of second emotion types. The second determining module 503 is further configured to: in a case that the plurality of first emotion types are consistent, determine a total emotion intensity of the plurality of first emotion types based on emotion intensities of the plurality of first emotion types and a weight used by an acoustic feature model for determining the plurality of first emotion types; in a case that the plurality of the second emotion types are consistent, determine a total emotion intensity of the plurality of second emotion types based on emotion intensities of the plurality of second emotion types and a weight used by a semantic understanding model for determining the plurality of second emotion types; and determine whether to retain the speech fragment based on the plurality of first emotion types, the total emotion intensity of the plurality of first emotion types, the plurality of second emotion types and the total emotion intensity of the plurality of second emotion types.

As a possible implementation of the embodiment of the disclosure, the second determining module 503 is further configured to: in a case that the plurality of first emotion types are inconsistent, or in a case that the plurality of second emotion types are inconsistent, determine not to retain the speech fragment.

As a possible implementation of the embodiment of the disclosure, the obtaining module 501 includes: an obtaining unit, a first processing unit, a second processing unit, a determining unit and a recognition unit. The obtaining unit is configured to obtain a plurality of speeches to be processed. The first processing unit is configured to obtain a speaker speech of at least one single speaker by performing an interference removal process and a speaker separation process for each of the plurality of speeches to be processed. The second processing unit is configured to obtain speaker speech fragments of the at least one single speaker by performing a voice activity detection and segmentation process on the speaker speech of the at least one single speaker. The determining unit is configured to determine the set of speech fragments based on the speaker speech fragments of the at least one single speaker. The recognition unit is configured to obtain the texts corresponding to the speech fragments by performing a speech recognition process on the speech fragments in the set of speech fragments.

As a possible implementation of the embodiment of the disclosure, the obtaining module 501 includes: a detecting unit and a removing unit. The detecting unit is configured to: for the speaker speech of the at least one single speaker, determine whether there is an overlapped fragment in the speaker speech by performing an overlapped speaker detection process on the speaker speech; and in a case that the overlapped fragment exists in the speaker speech, remove the overlapped fragment from the speaker speech.

As a possible implementation of the embodiment of the disclosure, the obtaining module 501 includes: a scoring unit and a filtering unit. The scoring unit is configured to: for each speaker speech fragment of the at least one single speaker, obtain an audio quality score of the speaker speech fragment by performing an audio quality scoring process on the speaker speech fragment. The filtering unit is configured to: perform a filtering process on the speaker speech fragment based on the audio quality score and a duration of the speaker speech fragment.

As a possible implementation of the embodiment of the disclosure, the filtering unit is further configured to: in a case that the audio quality score is less than or equal to a score threshold, or in a case that the duration is not within a duration range, perform the filtering process on the speaker speech fragment.

As a possible implementation of the embodiment of the disclosure, the recognition unit is further configured to: determine, for each of the speech fragments, a language type to which the speech fragment belongs; select a target speech recognition model from a plurality of candidate speech recognition models based on the language type; and obtain the text output by the target speech recognition model by inputting the speech fragment into the target speech recognition model.

As a possible implementation of the embodiment of the disclosure, the speech dataset includes speech fragments of a plurality of language types. The apparatus further includes: a training module, configured to perform fine-tuning training on the acoustic feature model and the semantic understanding model based on the speech fragments of the plurality of language types in the speech dataset and the texts corresponding to the speech fragments respectively.

According to the apparatus for determining the speech dataset in the embodiments of the disclosure, the set of speech fragments and the texts corresponding to the speech fragments in the set of speech fragments are obtained. For each of the speech fragments, The first emotion type of THE speech fragment, the emotion intensity of the first emotion type, the second emotion type of the corresponding text, and the emotion intensity of the second emotion type are determined. It is determined whether to retain the speech fragments based on the first emotion type, the emotion intensity of the first emotion type, the second emotion type and the emotion intensity of the second emotion type. Finally, the speech dataset is determined based on the speech fragments retained in the set of speech fragments and the texts corresponding to the speech fragments retained. Therefore, determining whether to retain the speech segment based on the emotion intensity of the emotion type ensures the emotion intensity of the emotion type of the speech fragment in the speech dataset. Moreover, the speech synthesis model trained based on the speech dataset is able to synthesize speeches expressing real emotions.

In order to implement the above embodiments, the disclosure also provides an apparatus for training a speech synthesis model. As illustrated in FIG. 6, FIG. 6 is a schematic diagram of a fifth embodiment of the disclosure. The apparatus 60 for training the speech synthesis model includes: a first obtaining module 601, a second obtaining module 602, and a training module 603.

The first obtaining module 601 is configured to obtain a speech dataset, in which the speech dataset includes speech fragments, emotion types of the speech fragments and texts corresponding to the speech fragments, and the speech dataset is determined according to the method for determining the speech dataset shown in FIG. 1 or FIG. 2.

The second obtaining module 602 is configured to obtain an initial speech synthesis model.

The training module 603 is configured to obtain a trained speech synthesis model by training the initial speech synthesis model based on the speech fragments, the emotion types of the speech fragments and the texts.

According to the apparatus for training the speech synthesis model of the embodiments of the disclosure, the speech dataset is obtained, in which the speech dataset includes the speech fragments, the emotion types of the speech fragments and the texts corresponding to the speech fragments, and the speech dataset is determined according to the method for determining the speech dataset shown in FIG. 1 or FIG. 2. The initial speech synthesis model is obtained, and the trained speech synthesis model is obtained by training the initial speech synthesis model based on the speech fragments, the emotion types of the speech fragments and the texts. Since the emotion intensities of the emotion types of the speech fragments in the speech dataset are higher, the speech synthesis model is able to synthesize speech fragments expressing real emotions.

In the technical scheme of the disclosure, collection, storage, usage, processing, transmission, provision and disclosure of users'personal information are all carried out with the consent of users, and all comply with the provisions of relevant laws and regulations and do not violate public order and good customs.

According to the embodiments of the disclosure, the disclosure also provides an electronic device, a readable storage medium and a computer program product.

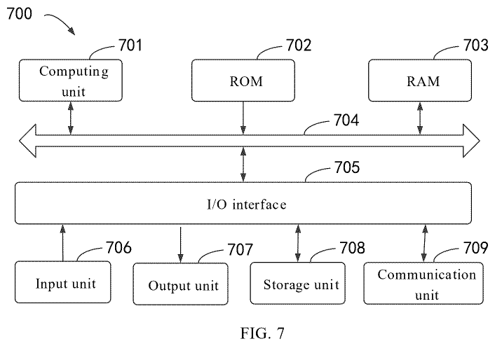

FIG. 7 is a schematic block diagram of an example electronic device 700 used to implement the embodiments of the disclosure. The electronic device is intended to represent various forms of digital computers, such as a laptop computer, a desktop computer, a workbench, a personal digital assistant, a server, a blade server, a mainframe computer and other suitable computers. The electronic device may also represent various forms of mobile devices, such as a personal digital processor, a cellular phone, a smart phone, a wearable device and other similar computing devices. The components shown here, their connections and relations, and their functions are merely exemplary, and are not intended to limit the implementations described and/or required in the disclosure.

As illustrated in FIG. 7, the device 700 includes: a computing unit 701 for performing various appropriate actions and processes according to computer programs stored in a read-only memory (ROM) 702 or computer programs loaded from a storage unit 708 to a random access memory (RAM) 703. The RAM 703 may also stores necessary programs and data for the device 700 to operate. The computing unit 701, the ROM 702 and the RAM 703 are connected to each other through a bus 704. An input/output (I/O) interface 705 is also connected to the bus 704.

Components in the device 700 are connected to the I/O interface 705, including: an input unit 706, such as a keyboard and a mouse; an output unit 707, such as various types of displays and speakers; the storage unit 708, such as a disk and an optical disk; and a communication unit 709, such as a network card, a modem and a wireless communication transceiver. The communication unit 709 allows the device 700 to exchange information/data with other devices through a computer network such as the Internet and/or various telecommunication networks.

The computing unit 701 may be various general-purpose and/or dedicated processing components having processing and computing capabilities. Some examples of the computing unit 701 include, but are not limited to, a central processing unit (CPU), a graphics processing unit (GPU), various dedicated artificial intelligence (AI) computing chips, various computing units that run machine learning (ML) model algorithms, a digital signal processor (DSP) and any appropriate processor, controller or microcontroller. The computing unit 701 executes the various methods and processes described above, e.g., the method for determining the speech dataset or the method for training the speech synthesis model. For example, in some embodiments, the method for determining the speech dataset or the method for training the speech synthesis model may be implemented as a computer software program, which is tangibly contained in a machine readable medium, such as the storage unit 708. In some embodiments, part or all of the computer programs may be loaded and/or installed on the device 700 via the ROM 702 and/or the communication unit 709. When the computer program is loaded on the RAM 703 and executed by the computing unit 701, one or more steps of the method for determining the speech dataset or the method for training the speech synthesis model may be executed. Alternatively, in other embodiments, the computing unit 701 may be configured to perform the method for determining the speech dataset or the method for training the speech synthesis model in any other suitable manner (for example, by means of firmware).

Various implementations of the systems and techniques described above may be implemented by a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware/firmware/software, and/or any combination thereof. These implementations may be implemented in one or more computer programs, the one or more computer programs may be executed and/or interpreted on a programmable system including at least one programmable processor. The programmable processor may be a dedicated or general programmable processor for receiving data and instructions from a storage system, at least one input device and at least one output device, and transmitting data and instructions to the storage system, the at least one input device and the at least one output device.

The program code used to implement the method of the disclosure may be written in any combination of one or more programming languages. These program codes may be provided to a processor/controller of a general-purpose computer, a dedicated computer or any other programmable data processing device, so that when the program codes are executed by the processor/controller, the functions/operations specified in the flowcharts and/or block diagrams are implemented. The program codes may be executed entirely on the machine, partly executed on the machine, partly executed on the machine and partly executed on the remote machine as an independent software package or entirely executed on the remote machine/server.

In the context of the disclosure, a machine-readable medium may be a tangible medium that may contain or store a program for use by or in combination with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system/apparatus/device, or any suitable combination of the above. More specific examples of the machine-readable storage medium include electrical connections based on one or more wires, portable computer disks, hard disks, RAMs, ROMs, electrically programmable ROMs (EPROMs) or flash memories, fiber optics, compact disc ROMs (CD-ROMs), optical storage devices, magnetic storage devices, or any suitable combination of the foregoing.

In order to provide interaction with a user, the systems and techniques described herein may be implemented on a computer having a display device (e.g., a cathode ray tube (CRT) or a liquid crystal display (LCD) monitor) for displaying information to the user; and a keyboard and a pointing device (such as a mouse or a trackball) through which the user can provide input to the computer. Other kinds of devices may also be used to provide interaction with the user. For example, feedback provided to the user may be any form of sensory feedback (e.g., visual feedback, auditory feedback or haptic feedback), and the input from the user may be received in any form (including acoustic input, speech input or tactile input).

The systems and technologies described herein can be implemented in a computing system that includes back-end components (for example, a data server), a computing system that includes middleware components (for example, an application server), a computing system that includes front-end components (for example, a user computer with a graphical user interface or a web browser, through which the user can interact with the implementations of the systems and technologies described herein), or a computing system that includes any combination of such back-end components, middleware components and front-end components. The components of the system may be interconnected by any form or medium of digital data communication (e.g., a communication network). The communication network may include, for example, a local area network (LAN), a wide area network (WAN), and the Internet.

The computer system may include a client and a server. The client and the server are generally remote from each other and interacting through a communication network. The client-server relation is generated by computer programs running on the respective computers and having a client-server relation with each other. The server may be a cloud server, a server with a distributed system, or a server combined with a block-chain.

It is understandable that the steps can be reordered, added or deleted using various forms of the processes shown above. For example, the steps in the disclosure may be performed in parallel, sequentially or in different orders, as long as the desired results of the technical solutions disclosed in the disclosure are achieved, which is not limited herein.

The specific implementations described above do not constitute a limitation on the scope of protection of the disclosure. It should be understood by those skilled in the art that various modifications, combinations, sub-combinations and substitutions can be made depending on the design requirements and other factors. Any modifications, equivalent substitutions and improvements made within the spirit and principles of the disclosure shall be included in the scope of protection of the disclosure.

What is claimed is:

1. A method for determining a speech dataset, comprising:
obtaining a set of speech fragments and obtaining texts corresponding to the speech fragments respectively;
determining, for each of the speech fragments, a first emotion type of the speech fragment, an emotion intensity of the first emotion type, a second emotion type of a text corresponding to the speech fragment, and an emotion intensity of the second emotion type;
determining whether to retain the speech fragment based on the first emotion type, the emotion intensity of the first emotion type, the second emotion type and the emotion intensity of the second emotion type; and
determining a speech dataset based on speech fragments retained in the set of speech fragments and texts corresponding to the speech fragments retained.

2. The method of claim 1, wherein determining, for each of the speech fragments, the first emotion type of the speech fragment, the emotion intensity of the first emotion type, the second emotion type of the text corresponding to the speech fragment, and the emotion intensity of the second emotion type comprises:
inputting the speech fragment into an acoustic feature model, and obtaining at least one first candidate emotion type, and a first probability and an emotion intensity of the at least one first candidate emotion type output by the acoustic feature model;
selecting the first emotion type from the at least one first candidate emotion type based on the first probability;
inputting the speech fragment into a semantic understanding model, and obtaining at least one second candidate emotion type, and a second probability and an emotion intensity of the at least one second candidate emotion type output by the semantic understanding model; and
selecting the second emotion type from the at least one second candidate emotion type based on the second probability.

3. The method of claim 1, wherein determining whether to retain the speech fragment based on the first emotion type, the emotion intensity of the first emotion type, the second emotion type and the emotion intensity of the second emotion type comprises:
determining whether the first emotion type is consistent with the second emotion type, and determining whether the emotion intensity of the first emotion type and the emotion intensity of the second emotion type are greater than or equal to an emotion intensity threshold; and
in a case that the first emotion type is consistent with the second emotion type, and the emotion intensity of the first emotion type and the emotion intensity of the second emotion type are both greater than or equal to the emotion intensity threshold, determining to retain the speech fragment.

4. The method of claim 3, wherein determining whether to retain the speech fragment based on the first emotion type, the emotion intensity of the first emotion type, the second emotion type and the emotion intensity of the second emotion type comprises:
in a case that the first emotion type is inconsistent with the second emotion type, or in a case that the emotion intensity of the first emotion type is less than the emotion intensity threshold, or in a case that the emotion intensity of the second emotion type is less than the emotion intensity threshold, determining not to retain the speech fragment.

5. The method of claim 1, wherein the first emotion type comprises a plurality of first emotion types and the second emotion type comprises a plurality of second emotion types, and determining whether to retain the speech fragment based on the first emotion type, the emotion intensity of the first emotion type, the second emotion type and the emotion intensity of the second emotion type comprises:
in a case that the plurality of first emotion types are consistent, determining a total emotion intensity of the plurality of first emotion types based on emotion intensities of the plurality of first emotion types and a weight used by an acoustic feature model for determining the plurality of first emotion types;
in a case that the plurality of the second emotion types are consistent, determining a total emotion intensity of the plurality of second emotion types based on emotion intensities of the plurality of second emotion types and a weight used by a semantic understanding model for determining the plurality of second emotion types; and
determining whether to retain the speech fragment based on the plurality of first emotion types, the total emotion intensity of the plurality of first emotion types, the plurality of second emotion types and the total emotion intensity of the plurality of second emotion types.

6. The method of claim 5, wherein determining whether to retain the speech fragment based on the first emotion type, the emotion intensity of the first emotion type, the second emotion type and the emotion intensity of the second emotion type comprises:
in a case that the plurality of first emotion types are inconsistent, or in a case that the plurality of second emotion types are inconsistent, determining not to retain the speech fragment.

7. The method of claim 1, wherein obtaining the set of speech fragments and obtaining the texts corresponding to the speech fragments respectively comprises:
obtaining a plurality of speeches to be processed;
obtaining a speaker speech of at least one single speaker by performing an interference removal process and a speaker separation process for each of the plurality of speeches to be processed;
obtaining speaker speech fragments of the at least one single speaker by performing a voice activity detection and segmentation process on the speaker speech of the at least one single speaker;
determining the set of speech fragments based on the speaker speech fragments of the at least one single speaker; and
obtaining the texts corresponding to the speech fragments by performing a speech recognition process on the speech fragments respectively.

8. The method of claim 7, wherein before obtaining the speaker speech fragments of the at least one single speaker by performing the voice activity detection and segmentation process on the speaker speech of the at least one single speaker, the method further comprises:
for the speaker speech of the at least one single speaker, determining whether an overlapped fragment exists in the speaker speech by performing an overlapped speaker detection process on the speaker speech; and
in a case that the overlapped fragment exists in the speaker speech, removing the overlapped fragment from the speaker speech.

9. The method of claim 7, wherein before determining the set of speech fragments based on the speaker speech fragments of the at least one single speaker, the method further comprises:
for each speaker speech fragment of the at least one single speaker, obtaining an audio quality score of the speaker speech fragment by performing an audio quality scoring process on the speaker speech fragment; and
performing a filtering process on the speaker speech fragment based on the audio quality score and a duration of the speaker speech fragment.

10. The method of claim 9, wherein performing the filtering process on the speaker speech fragment based on the audio quality score and the duration of the speaker speech fragment comprises:
in a case that the audio quality score is less than or equal to a score threshold, or in a case that the duration is not within a duration range, performing the filtering process on the speaker speech fragment.

11. The method of claim 7, wherein obtaining the texts corresponding to the speech fragments by performing the speech recognition process on the speech fragments respectively comprises:
determining, for each of the speech fragments, a language type to which the speech fragment belongs;
selecting a target speech recognition model from a plurality of candidate speech recognition models based on the language type; and
obtaining the text output by the target speech recognition model by inputting the speech fragment into the target speech recognition model.

12. The method of claim 2, wherein the speech dataset comprises speech fragments of a plurality of language types, and the method further comprises:
performing fine-tuning training on the acoustic feature model and the semantic understanding model based on the speech fragments of the plurality of language types in the speech dataset and the texts corresponding to the speech fragments respectively.

13. A method for training a speech synthesis model, comprising:
obtaining a speech dataset, wherein the speech dataset comprises speech fragments, emotion types of the speech fragments and texts corresponding to the speech fragments, and the speech dataset is determined according to the method for determining the speech dataset according to claim 1;
obtaining an initial speech synthesis model; and
obtaining a trained speech synthesis model by training the initial speech synthesis model based on the speech fragments, the emotion types of the speech fragments and the texts.

14. An electronic device, comprising:
at least one processor; and
a memory communicatively connected to the at least one processor;
wherein the memory stores instructions executable by the at least one processor, and when the instructions are executed by the at least one processor, the at least one processor is caused to:
obtain a set of speech fragments and obtain texts corresponding to the speech fragments respectively;
determine, for each of the speech fragments, a first emotion type of the speech fragment, an emotion intensity of the first emotion type, a second emotion type of a text corresponding to the speech fragment, and an emotion intensity of the second emotion type;
determine whether to retain the speech fragment based on the first emotion type, the emotion intensity of the first emotion type, the second emotion type and the emotion intensity of the second emotion type; and
determine a speech dataset based on speech fragments retained in the set of speech fragments and texts corresponding to the speech fragments retained.

15. The electronic device of claim 14, wherein determine, for each of the speech fragments, the first emotion type of the speech fragment, the emotion intensity of the first emotion type, the second emotion type of the text corresponding to the speech fragment, and the emotion intensity of the second emotion type comprises:
input the speech fragment into an acoustic feature model, and obtain at least one first candidate emotion type, and a first probability and an emotion intensity of the at least one first candidate emotion type output by the acoustic feature model;
select the first emotion type from the at least one first candidate emotion type based on the first probability;
input the speech fragment into a semantic understanding model, and obtain at least one second candidate emotion type, and a second probability and an emotion intensity of the at least one second candidate emotion type output by the semantic understanding model; and
select the second emotion type from the at least one second candidate emotion type based on the second probability.

16. An electronic device, comprising:
at least one processor; and
a memory communicatively connected to the at least one processor;
wherein the memory stores instructions executable by the at least one processor, and when the instructions are executed by the at least one processor, the at least one processor is caused to implement the method according to claim 13.

17. A non-transitory computer-readable storage medium, wherein the medium stores computer instructions, and the computer instructions are used to cause a computer to implement the method according to claim 1.

18. A non-transitory computer-readable storage medium, wherein the medium stores computer instructions, and the computer instructions are used to cause a computer to implement the method according to claim 13.

19. A computer program product, wherein the product comprises computer programs, and when the computer programs are executed by a processor, the method according to claim 1 is implemented.

20. A computer program product, wherein the product comprises computer programs, and when the computer programs are executed by a processor, the method according to claim 13 is implemented.
